(19) United States
(12) Patent Application Publication
(10) Pub. No.: US 2006/0245340 A1
(43) Pub. Date: Nov. 2, 2006

(54) OPTICAL DISK SUBSTRATE AND OPTICAL DISK

(75) Inventor: Yi-Lin Chu, Hsinchu (TW)

Correspondence Address: PAI PATENT & TRADEMARK LAW FIRM, 1001 FOURTH AVENUE, SUITE 3200, SEATTLE, WA, 98154, US

(73) Assignees: PRINCO CORP., Hsinchu (TW); PRINCO AMERICA CORP., Fremont, CA (US)

(21) Appl. No.: 11/162,510

(22) Filed: Sep. 13, 2005

(30) Foreign Application Priority Data
Apr. 28, 2005 (TW) 094113748

(51) Int. Cl. G11B 7/24

(52) U.S. Cl. 369/275.1

(57) ABSTRACT

An optical disk substrate includes an annular substrate and a protruding portion. The annular substrate has an inner supporting portion and an outer recording portion having a recording surface. The protruding portion overlaying on the supporting portion has a plurality of indentations on its outer periphery, wherein the total thickness of the protruding portion and the supporting portion is greater than the thickness of the recording portion. An optical disk, wherein a paint layer for recording data is coated on the recording surface of the disk substrate, is also disclosed.

### BACKGROUND OF THE INVENTION

a) Field of the Invention

The invention relates to an optical disk substrate and an optical disk, and more particularly to an optical disk substrate and an optical disk that are easy to manufacture at reduced cost.

b) Description of the Related Art

An optical disk can store data with different formats, such as image, computer digital image, and text; therefore, an optical disk is the most convenient storage medium among the new generation optical storage media. In addition, an optical disk can be applied in many fields, including library archives, data backup, electronic publication, image data storage, and personal medical record management.

Please refer to FIG. 1A, which is a top view of a conventional optical disk 1. The conventional optical disk 1, which is annular as shown in FIG 1A, is divided into a supporting portion 11 on the inner side of the circle and a recording portion 12 on the outer side of the circle. FIG. 1B illustrates the detailed structure of the conventional optical disk 1; the conventional optical disk 1 includes a substrate 14, a paint layer 15, and a compensation sheet 16. The paint layer 15 includes a recording layer 151, a reflection layer 152, and a protection layer 153, which are sequentially stacked on the substrate 14 to form the recording portion 12. Then the compensation sheet 16 and the substrate 14 are bonded together to form the optical disk 1. The substrate 14 has a thickness of 0.6 mm and the compensation sheet 16 also has a thickness of 0.6 mm, so that the supporting portion 11 of the optical disk 1 has a thickness of 1.2 mm for an optical disk drive to clamp thereto.

However, there are problems remaining in producing conventional optical disks. The substrate 14 and the compensation sheet 16 of the conventional optical disk 1 are required to be correspondently bonded after they have been separately formed, which in turn increases the complexity and difficulty of the production and thus unqualified products are easily produced. Thereby, the production cost cannot be effectively reduced. Also, the optical disk 1 needs to be strengthened by the compensation sheet 16 so that when the optical disk 1 is revolving in the optical disk drive, the optical disk will not be distorted due to high-speed revolution; the addition of the compensation sheet 16 further increases the material cost. Thus, how to effectively reduce the material cost and to easily manufacture optical disks with increased yield while maintaining the rigidity of the optical disk has always been the goal for the industry.

### BRIEF SUMMERY OF THE INVENTION

In view of the aforementioned problems, an object of the invention is to provide an optical disk substrate and an optical disk that can be manufactured easily at reduced cost with increased yield.

The optical disk substrate of the invention includes an annular substrate and a protruding portion. The annular substrate has an inner supporting portion and an outer recording portion with a recording surface. The protruding portion is overlaid on the supporting portion, wherein the protruding portion has a supporting surface that is on a different plane from the recording surface, and has a plurality of indentations on the outer periphery of the protruding portion. The total thickness of the protruding portion and the supporting portion is greater than the thickness of the recording portion. The optical disk of the invention includes a paint layer formed on the recording surface of the optical disk substrate for data recording.

According to the optical disk substrate and optical disk of the invention, since the total thickness of the protruding portion and the supporting portion is greater than the thickness of the recording portion, the optical disk can be directly clamped by an optical disk drive. Thus the rigidity can be enhanced and the warping of the substrate can be prevented. Moreover, the indentations of the protruding portion can minimize the material cost of producing optical disk substrates and lower the internal stress of the optical disk substrate after injection molding, so that an optical disk with excellent optical characteristics can be obtained. An inclined plane provided on the protruding portion allows an injection mold to be filled with the plasticized material more smoothly during the injection molding process of the optical disk substrate, which in turn decreases the output of unqualified products.

### BRIEF DESCRIPTION OF THE DRAWINGS

FIG. 1A illustrates a top view of a conventional optical disk

FIG. 1B illustrates a sectional view of a conventional optical disk

FIG. 2A illustrates a top view of an optical disk substrate according to a preferred embodiment of the invention

FIG. 2B illustrates a sectional view of an optical disk substrate according to a preferred embodiment of the invention

FIG. 2C illustrates a sectional view of an optical disk substrate according to another preferred embodiment of the invention

FIG. 3 illustrates a sectional view of an optical disk according to a preferred embodiment of the invention

FIG. 4 illustrates a sectional view of an optical disk according to another preferred embodiment of the invention

FIG. 5A is an optical characteristic diagram showing relative double refraction index of a conventional optical disk

FIG. 5B is an optical characteristic diagram showing relative double refraction index of an optical disk according to a preferred embodiment of the invention

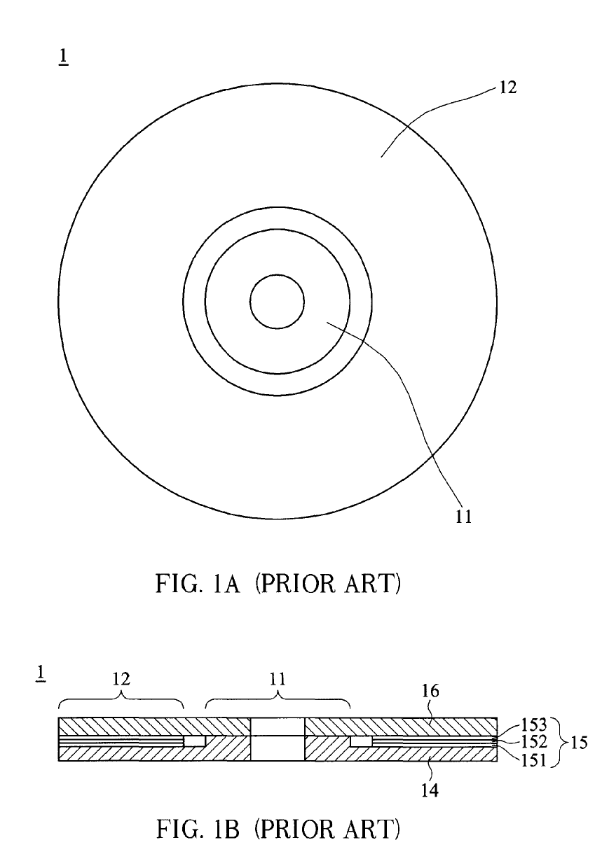

### DETAILED DESCRIPTION OF THE INVENTION

The optical disk substrate and optical disk according to a preferred embodiment of the invention will be described below with reference to the drawings, wherein the like reference numerals denote the like components.

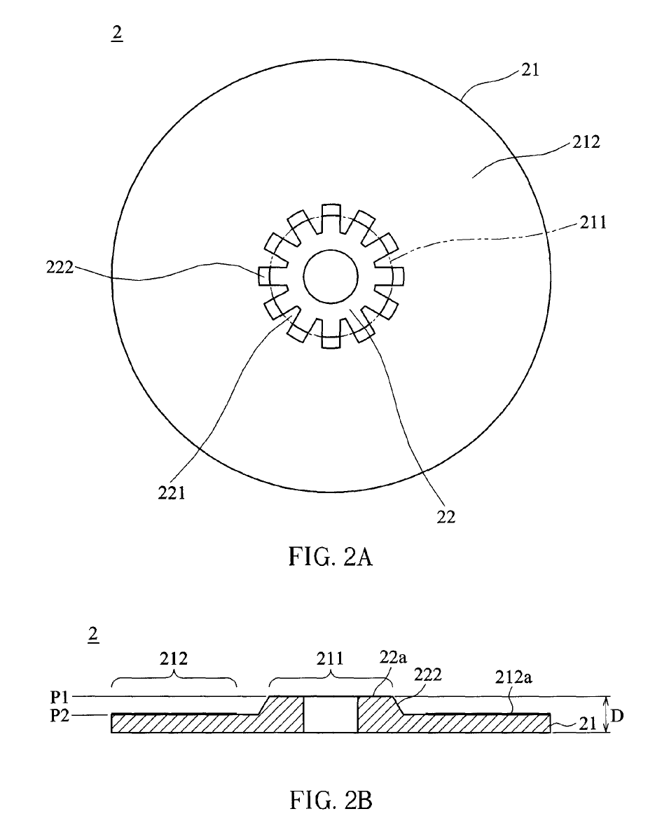

As shown in FIGS. 2A and 2B, an optical disk substrate 2 according to a preferred embodiment of the invention includes an annular substrate 21 and a protruding portion 22. The annular substrate 21 is provided with a supporting portion 211 on the inner side and a recording portion 212 on the outer side. The recording portion 212 has a recording surface 212a, on which a paint layer, which would be described later, is formed. The protruding portion 22 is overlaid on the supporting portion 211 and has a supporting surface 22a. The thickness between 0.66 mm and 1.6 mm is reached when the protruding portion 22 is laid over the supporting portion 211 of the annular substrate 21; this is the total thickness (D) of the protruding portion and the supporting portion. Such thickness allows the optical disk drive to clamp onto the supporting surface 22a for read/write operations when the optical disk is placed into the optical disk drive. On the other hand, the recording portion 212 of the annular substrate 21 has a thickness between 0.55 mm and 0.65 mm, and hence, the supporting surface 22a and the recording surface 212a are not coplanar. In other words, the plane P1, on which the supporting surface 22a is located, differs from the plane P2, on which the recording surface 212a is located. The two planes can be on the same side of the annular substrate 12 as shown in FIG. 2B, or they can be on different sides of the annular substrate 12 as shown in FIG. 2C. In addition, a plurality of indentations 221, which are formed around the rim of the protruding portion in such a way that the protruding portion 22 could be a gear wheel shape or a petal like shape, are provided on the outer periphery of the protruding portion 22. It is to be noted that the annular substrate 21 and the protruding portion 22 can be molded in one piece, for example by injection molding, or can be assembled by bonding to one another. The diameter of the annular substrate 21 is between 70 mm and 90 mm with a preference of 80 mm, or between 110 mm and 130 mm with a preference of 120 mm, or a dimension other than the above-mentioned.

The optical disk substrate according to the embodiment of the invention further includes an inclined plane 222 extending from the plane P1 on which the supporting surface 22a is located to the plane P2 on which the recording surface 212a is located, and the inclined plane 222 is the outermost periphery of the protruding portion 22.

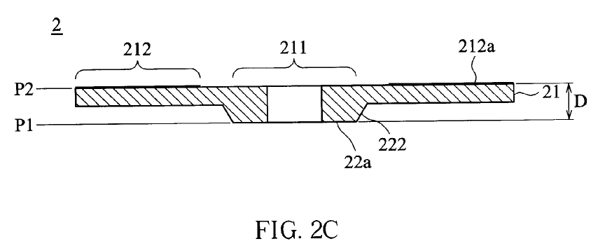

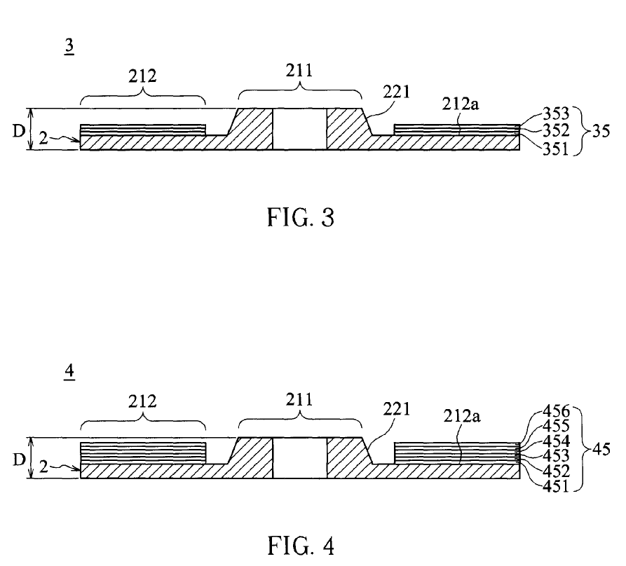

FIGS. 3 and 4 illustrate two optical disks 3 and 4, respectively, according to the preferred embodiments of the invention. The optical disks 3 and 4 each includes an optical disk substrate 2 and a paint layer 35, 45, respectively. The structural characteristic of the optical disk substrate 2 is as aforementioned and is not further described hereinafter, and the paint layer 35 is formed on the recording surface 212a for recording data. Different optical disks with paint layers 35, 45 of different compositions are used in different applications. For example, the paint layer 35 shown in FIG. 3 is formed by stacking a recording layer 351, a reflection layer 352, and a protection layer 353 sequentially on the recording surface 212a, wherein the recording layer 351 is composed of dyes and the reflection layer 352 is composed of metal. The paint layer 45 shown in FIG. 4 is formed with a first dielectric layer 451, a recording layer 452, a second dielectric layer 453, an insulation layer 454, a reflection layer 455, and a protection layer 456 sequentially stacked on the recording surface 212a, wherein the recording layer 452 is composed of alloy and its upper and lower separation layers, and the reflection layer 455 is composed of metal. The optical disk 4 made thereof is a phase change optical disk. The optical disks 3 and 4 can be used as DVD categories, High-Density DVD categories and other double-sided disc applications.

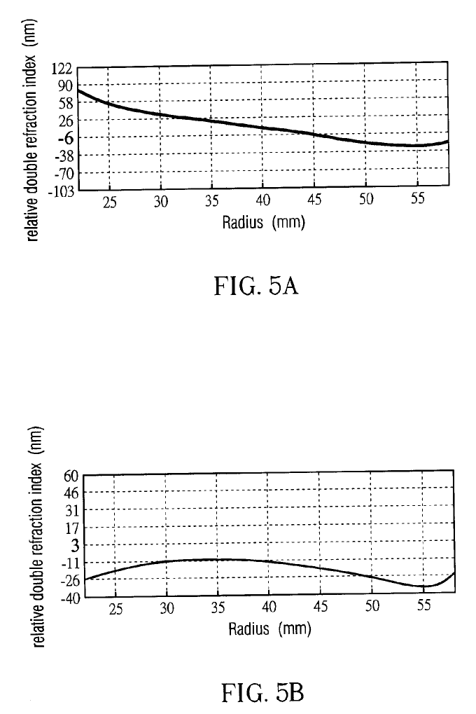

Besides fulfilling the requirement for structural rigidity and warping, the optical disk substrate and the optical disk of the invention also have better optical characteristics. Referring to FIGS. 5A and 5B, FIG. 5A is an optical characteristic diagram illustrating the relative double refraction index of an optical disk without the indentations 221, and FIG. 5B is an optical characteristic diagram illustrating the relative double refraction index of an optical disk of the invention. The average values of the relative double refraction index for the conventional optical disks with radii of 22.8 mm, 40.0 mm, and 57.3 mm are 74 nm, 10 nm, and −25 nm, respectively, while the average values of relative double refraction index for the optical disks of the invention with the same radii are −19 nm, −8 nm, and −24 nm, respectively, which are lower than that of the conventional optical disks and thereby have more desirable optical characteristics.

According to the optical disk substrate and the optical disk of the invention, the total thickness of the protruding portion of the optical disk substrate and the supporting portion is large enough to be directly clamped by the optical disk drive, and so a compensation sheet is not needed to increase the thickness of the optical disk. Also, the rigidity of the optical disk substrate with a thicker supporting portion can prevent the annular substrate from warping, so that the optical disk substrate can be manufactured more easily and a higher yield can be obtained. The indentations of the protruding portion reduce the material cost of manufacturing the optical disk substrate while maintaining the rigidity of the optical disk substrate, and the internal stress of the optical disk substrate is lowered; hence, the optical disk substrate has more desirable optical characteristics. Moreover, the inclined plane on the outer periphery of the protruding portion allows the mold to be filled with the plasticized material more smoothly during the injection molding process, which reduces the output of unqualified products, and in turn lowers the production cost.

While the invention has been described by way of examples and in terms of the preferred embodiments, it is to be understood that the invention is not limited to the disclosed embodiments. In other words, it is intended to include equivalent modifications and changes of the above embodiments without departing from the spirit and scope of the invention as would be apparent to those skilled in the art. For example, though the preferred embodiment of the optical disk of the invention does not bond with any compensation sheet to increase the thickness and strength of the optical disk, people skilled in the art could bond compensation sheets thereto according to special requirements. Therefore, the scope of the appended claims should be accorded the broadest interpretation so as to encompass all such equivalent modifications and changes.

What is claimed is:

1. An optical disk substrate, comprising:
an annular substrate, having a supporting portion and a recording portion surrounding the supporting portion, the recording portion having a recording surface; and
a protruding portion overlaid on the supporting portion, the protruding portion having a supporting surface which is on a different plane from the recording surface and having a plurality of indentations on its outer periphery,
wherein the total thickness of the protruding portion and the supporting portion is greater than the thickness of the recording portion.

2. The optical disk substrate as described in claim 1, wherein the outermost periphery of the protruding portion is inclined outwards from the plane on which the supporting surface is located to the plane on which the recording surface is located.

3. The optical disk substrate as described in claim 1, wherein the total thickness of the protruding portion and the supporting portion is between 0.66 mm and 1.6 mm.

4. The optical disk substrate as described in claim 1, wherein the thickness of the recording portion is between 0.55 mm and 0.65 mm.

5. The optical disk substrate as described in claim 1, wherein the diameter of the annular substrate is between 70 mm and 90 mm.

6. The optical disk substrate as described in claim 1, wherein the diameter of the annular substrate is between 110 mm and 130 mm.

7. The optical disk substrate as described in claim 1, wherein the supporting surface and the recording surface are on the same side of the annular substrate.

8. The optical disk substrate as described in claim 1, wherein the supporting surface and the recording surface are on different sides of the annular substrate.

9. The optical disk substrate as described in claim 1, wherein the annular substrate and the protruding portion are molded in one piece.

10. The optical disk substrate as described in claim 1, wherein the annular substrate and the protruding portion are assembled.

11. An optical disk, comprising:
an optical disk substrate, which comprises:
an annular substrate, having a supporting portion and a recording portion surrounding the supporting portion, the recording portion having a recording surface; and
a protruding portion overlaid on the supporting portion, the protruding portion having a supporting surface which is on a plane different from the recording surface and having a plurality of indentations on its outer periphery,
wherein the total thickness of the protruding portion and the supporting portion is greater than the thickness of the recording portion; and
a paint layer formed on the recording surface for recording data.

12. The optical disk as described in claim 11, wherein the outermost periphery of the protruding portion is inclined outwards from the plane on which the supporting surface is located to the plane on which the recording surface is located.

13. The optical disk as described in claim 11, further comprising:
a compensation sheet overlaid on the paint layer.

14. The optical disk as described in claim 11, wherein the total thickness of the protruding portion and the supporting portion is between 0.66 mm and 1.6 mm.

15. The optical disk as described in claim 11, wherein the thickness of the recording portion is between 0.55 mm and 0.65 mm.

16. The optical disk as described in claim 11, wherein the diameter of the annular substrate is between 70 mm and 90 mm.

17. The optical disk as described in claim 11, wherein the diameter of the annular substrate is between 110 mm and 130 mm.

18. The optical disk as described in claim 11, wherein the supporting surface and the recording surface are on the same side of the annular substrate.

19. The optical disk as described in claim 11, wherein the supporting surface and the recording surface are on different sides of the annular substrate.

20. The optical disk as described in claim 11, wherein the annular substrate and the protruding portion are molded in one piece.

21. The optical disk as described in claim 11, wherein the annular substrate and the protruding portion are assembled.

22. The optical disk as described in claim 11, wherein the paint layer comprises:
at least one recording layer located on the recording surface;
a reflection layer located on the recording layer; and
a protection layer located on the reflection layer.

23. The optical disk as described in claim 22, wherein the recording layer is composed of dyes and the reflection layer is composed of metal.

24. The optical disk as described in claim 11, wherein the paint layer comprises:
a first dielectric layer located on the recording surface;
a recording layer located on the first dielectric layer;
a second dielectric layer located on the recording layer;
an insulation layer located on the second dielectric layer;
a reflection layer located on the insulation layer; and
a protection layer located on the reflection layer.

25. The optical disk as described in claim 24, wherein:
the recording layer is composed of alloy, an upper separation layer of the alloy, and a lower separation layer of the alloy; and
the reflection layer is composed of metal.
